(19) United States
(12) Patent Application Publication
(10) Pub. No.: US 2014/0137424 A1
(43) Pub. Date: May 22, 2014

(54) BOTTLE DRYING STAND

(71) Applicant: DART INDUSTRIES INC., Orlando, FL (US)

(72) Inventor: Julie L. Yessin, Orlando, FL (US)

(73) Assignee: Dart Industries Inc., Orlando, FL (US)

(21) Appl. No.: 13/683,402

(22) Filed: Nov. 21, 2012

(51) Int. Cl. F26B 25/18

(52) U.S. Cl. CPC F26B 25/18
USPC 34/104

(57) ABSTRACT

A bottle drying stand for a standard bottle having a side wall, transitioning through a shoulder to a bottle mouth. The stand includes a peripheral side wall resting upon a base rim. The upper end of the side wall forms a support rim sized for the inverted bottle to rest upon at its shoulder. A drip cup extends inwardly and downwardly from the support rim, and the mouth of the bottle is received therein. The drip cup includes a cup opening for airflow, preferably coaxial with the bottle mouth. The side wall of the stand also includes wall openings permitting airflow inward to communicate with the cup opening.

### CROSS REFERENCE TO RELATED APPLICATIONS

This application is related to co-pending design Ser. No. 29437867.

### STATEMENT REGARDING FEDERALLY SPONSORED RESEARCH

Not applicable.

### BACKGROUND OF THE INVENTION

The present invention relates in general to drying racks for dishes and bottles. In particular, the present invention relates to an improved bottle drying stand having excellent airflow for drying, reduced contact with the bottle for improved sanitation, as well as integrated drip retention.

Dish and bottle drying racks are well known. These typically take the form of a wire support structure resting upon a drip tray. For bottles in particular, it is common for the support structure to have a plurality of fingers or tines, each of which would serve to support a single bottle. The bottle would be inverted and the mouth of the bottle placed over the tine such that the tine supports the bottle from within. This arrangement presents several drawbacks. The bottle will be dried by airflow through the mouth of the bottle allowing moisture-laden air to exit the bottle. The tine partially blocks the mouth of the bottle, reducing this airflow. The tine also contacts the bottle at the mouth, and typically at least one other spot within the bottle interior. This presents the possibility of contaminating the bottle after it has been washed.

### SUMMARY OF THE INVENTION

An object of the present invention is to provide a bottle drying stand which provides an integrated arrangement for drying and drip retention.

Another object of the present invention is to provide a bottle drying stand which provides excellent airflow to the bottle interior.

Yet another object of the present invention is to provide a bottle drying stand which support the bottle without contact to the mouth or interior of the bottle.

These and other objects are achieved by a bottle drying stand for a standard bottle having a side wall, transitioning through a shoulder to a bottle mouth. The stand includes a peripheral side wall resting upon a base rim. The upper end of the side wall forms a support rim sized for the inverted bottle to rest upon at its shoulder. A drip cup extends inwardly and downwardly from the support rim, and the mouth of the bottle is received therein. The drip cup includes a cup opening for airflow, preferably coaxial with the bottle mouth. The side wall of the stand also includes wall openings permitting airflow inward to communicate with the cup opening. This stand provides a stable support, efficient drying airflow, eliminates contact with the bottle mouth and interior, and is suitable for simple mass production techniques.

### BRIEF DESCRIPTION OF THE DRAWINGS

The objects and features of the invention noted above are explained in more detail with reference to the drawings, in which like reference numerals denote like elements, and in which:

FIG. 1 is a top perspective view of a bottle drying stand according to the present invention together with a supported bottle;

FIG. 2 is a top isometric view of a stand as in FIG. 1;

FIG. 3 is a top plan view thereof;

FIG. 4 is a detail cross-sectional view of the stand and supported bottle along line 4-4 of FIG. 1; and

FIG. 5 is a top isometric view of a second embodiment of a bottle drying stand according to the present invention.

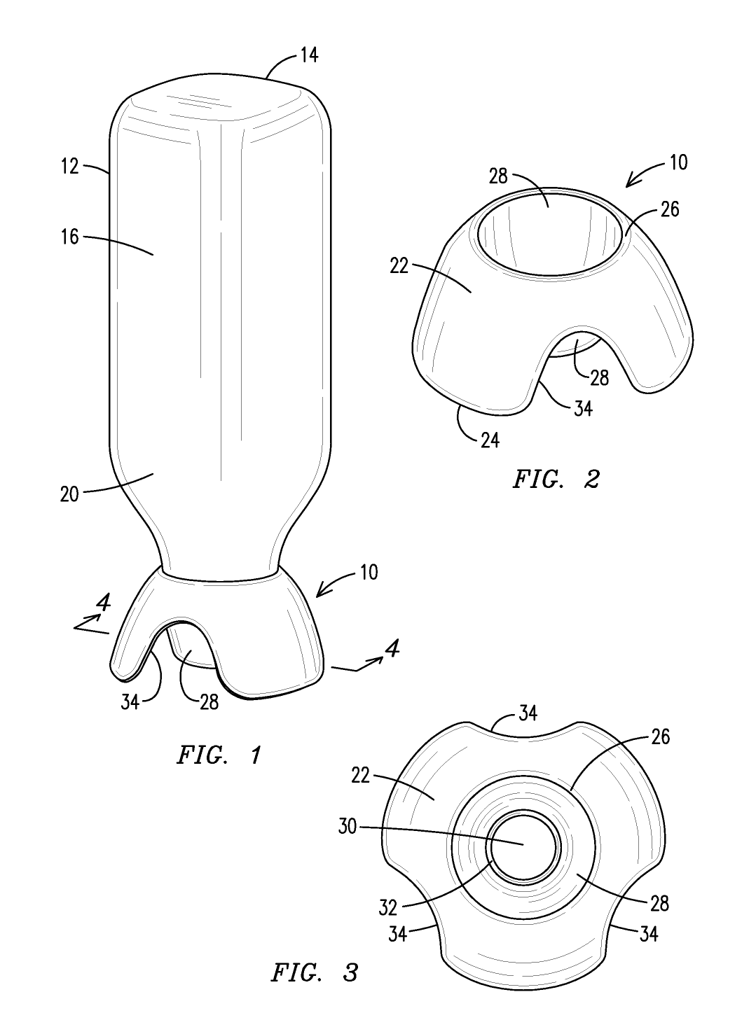

### DETAILED DESCRIPTION OF THE INVENTION

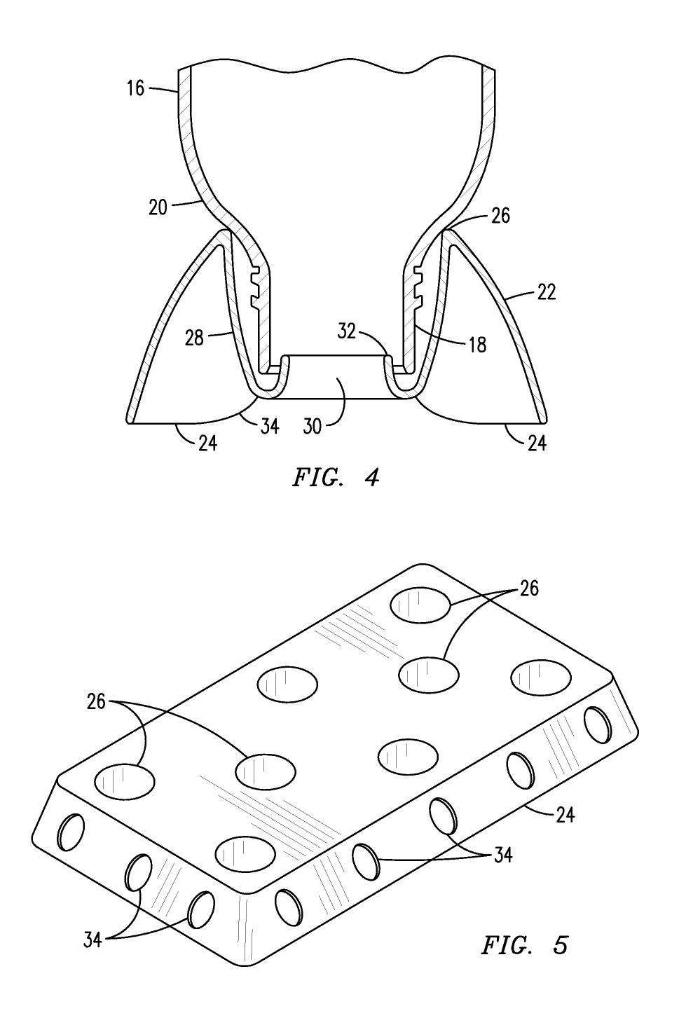

With reference to FIG. 1, a bottle drying stand according to the present invention is generally designated by reference numeral 10. As shown, the stand 10 is supporting a bottle 12 in the operative, inverted position. This bottle 12 is of the usual type known for reuse, and would commonly be employed as a baby feeding bottle, a water bottle, etc. The bottle 12 would generally include a base 14 with a peripheral sidewall 16 extending therefrom. This sidewall may be cylindrical as shown, possibly with curving contours for gripping, or could have a prismatic form. As an example of a prismatic form, baby bottles commonly have a hexagonal longitudinal cross-section for the sidewall 16. As is best shown in FIG. 4, the bottle 12 will have a cylindrical open mouth 18 at its longitudinal end, with this open mouth having a reduced diameter compared to sidewall 16. To accommodate this, a shoulder section 20 is formed as a transition between the sidewall 16 and mouth 18. Again as noted, this bottle 12 is of the usual prior art types.

The stand 10 includes a peripheral side wall 22 extending between a lower base edge 24 and a support rim 26. As show, the base edge 24 is a true edge, and the stand 10 is open at the bottom. While this is preferred, it is possible to form the stand 10 with an enclosing full base (not shown), or a partial base in the form of one or more tabs (not shown) extending laterally inward and/or outward from the base edge 24.

The support rim 26 is sized so as to be larger than the anticipated range of sizes for the bottle mouth 18, yet smaller than the anticipated range of sizes for the bottle sidewall 16, such that the support rim 26 will be sized to engage with the bottle 12 at the shoulder 20 to support the bottle 12 in the inverted position shown. The support rim 26 is preferably circular as shown, but could take various geometric shapes as desired so long as it continues to engage the shoulder 20 in a manner to support the inverted bottle 12 in a stable manner.

The bottle stand 10 further includes a drip cup 28 extending downward and inward from the support rim 26. Drip cup 28 is formed as a concave member opening upward at support rim 26, and is sized to receive the mouth 18 of bottle 12 without contact. As illustrated in FIG. 4, the bottle 12 will be fully supported on the stand 10 by the shoulder 20 resting upon the support rim 26. This is the operative, drying position of bottle 12. In this position, a portion of the shoulder 20 and the entirety of the mouth 18 will be received within the drip cup 28. As may be envisioned, when a bottle 12 is washed and then placed in the operative position on stand 10, water which drips from the open mouth 18 of the bottle 12 will be captured within the drip cup 28 thus saving the user's counter top from mess, and eliminating the need for a separate drip pan beneath the stand 10.

In order to increase the rate of drying, it is preferred that there be good airflow communicating with the mouth 18 of bottle 12. Some airflow is achieved between the shoulder 20 and the support rim 26. This is minimal, however, in the preferred arrangements where the shoulder 20 and support rim 26 are both circular. Greater airflow would be achieved where the shoulder 20 is circular but the support rim is a geometric shape, as this would create gaps between the two.

In the preferred embodiment, airflow to the bottle mouth 18 is improved by providing one or more cup openings 30 extending through the drip cup 28. While not shown in the Figures, the cup opening or openings could be located near the support rim and be sized such that the bottom (non-apertured) portion of the drip cup still has depth sufficient to retain the anticipated water dripping from bottle 12. It is preferred, however, that the cup opening 30 be located centrally at the lower longitudinal end of the drip cup 28, as shown in FIGS. 3 and 4. This location will allow airflow directly to and from the mouth 18 of the bottle for fastest drying.

Simply providing the cup opening 30 in this central lower location would allow the water dripping from bottle 12 to fall through, or flow through, the cup opening 30 onto the supporting counter or surface for the stand 10. It is greatly preferred for the drip cup 28 to retain its ability to capture and retain the water dripping from the bottle 12. To this end, it is preferred that the diameter (or polygonal equivalent) of the cup opening 30 be less than that of the anticipated range of bottle mouths 18, as best illustrated in FIG. 4. With this sizing, water dripping from the rim of the mouth 18 will fall outside the periphery of the cup opening 30 and within the drip cup 28.

Further, the peripheral edges of the cup opening 30 are raised longitudinally to form a cup lip 32. As such, the drip cup 28 will continue to form a reservoir to hold water dripping from the bottle 12, but instead of a wide circular reservoir, it will be generally annular in shape by surrounding the cup opening 30. The height of the cup lip 32 will be chosen to provide an adequate reservoir capacity to hold all water dripping from the bottle 12, but also sufficiently low to reduce the possibility of contact between the cup lip 32 and the bottle mouth 18. In this regard, it is noted that the smaller diameter of the cup lip 32 would allow the cup lip to be received slightly within the bottle mouth 18 in the operative position and thus avoid contact, as shown in FIG. 4.

This central placement of the cup opening 30 allows for maximum air transfer from and to the bottle mouth 18 through the drip cup 28. The drip cup 28 is, however, located within the side wall 22. While this may be sufficient for some situations, it is preferred that the stand 10 further include free air transfer through the side wall 22 to allow maximum airflow communication between the environment and the bottle mouth 18.

To this end, it is preferred that the stand side wall 22 include one or more wall openings 34. These might take the form of apertures extending through the side wall 22 (FIG. 5). It is preferred, however, that the wall openings 34 be formed as notches extending upwardly from the base edge 24, with the remaining lower portion of the side wall 22 thereby defining spaced legs supporting the stand 10.

As shown and described, the bottle drying stand 10 may be readily formed as a monolithic unit by mass-produced, injection-molded plastic processes. In use, the stand 10 will support the bottle 12 in a stable manner as shown. Water dripping from the inverted bottle 12 will not fall from through the cup opening 30, but will rather be captured within the drip cup 28. This will eliminate the need for a separate drip tray beneath the stand 10, and will maintain the counter or support surface for the stand 10 in a clean, dry condition. The wall openings 34 and cup opening 30 will provide excellent air transfer to the mouth of the bottle 18, ensuring the quickest drying. The structure of the stand 10 will ensure that the bottle mouth 18 is received within the stand 10 and supported using only the support rim 26, with the bottle mouth remaining spaced from the drip cup 28 and cup lip 32. This will prevent contamination of the cleaned bottle 12 by the stand 10.

The embodiment described above meets all the desired criteria for an improved bottle drying stand. As noted, some modifications are possible while still meeting these criteria. One further possible modification would be to provide for drying more than a single bottle. To this end, each stand 10 could have the side wall 22 formed in a manner to permit interconnection with one or more identically formed stands 10, as is known in the art. A different solution could alternatively be to simply form the stand 10 in a larger (that is wider) form similar to a tray as shown in FIG. 5. This would allow multiple drip cups 28 to be formed within the single stand, as shown.

From the foregoing it will be seen that this invention is one well adapted to attain all ends and objects set forth above together with the other advantages which are inherent within its structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth of shown in the accompanying drawings is to be interpreted as illustrative, and not in a limiting sense.

What is claimed is:

1. A bottle drying stand for use with a standard bottle having a side wall transitioning through a shoulder to a bottle mouth, said stand comprising:
a peripheral side wall resting upon a base rim, an upper end of said side wall forming a support rim sized for said bottle shoulder to rest upon with said bottle in an inverted position;
drip cup extending inwardly and downwardly from said support rim and intended for said mouth of said bottle to be received therein with said drip cup acting as a reservoir for water drops exiting said bottle mouth, said drip cup including at least one cup opening extending therethrough for airflow and being sized a located so as not to interfere with said reservoir function of said drip cup.

2. A stand as in claim 1, wherein said side wall of said stand further includes at least one wall openings permitting airflow inward to communicate with said cup opening.

3. A stand as in claim 2, wherein said wall openings are comprised by notches formed in said base rim.

4. A stand as in claim 3, wherein said cup opening is located centrally, and is surrounded by a cup lip extending upwardly therefrom.

5. A stand as in claim 4, wherein said cup opening is sized to be smaller than the diameter of said bottle mouth.

6. A stand as in claim 1, wherein said cup opening is located centrally, and is surrounded by a cup lip extending upwardly therefrom.

7. A stand as in claim 6, wherein said cup opening is sized to be smaller than the diameter of said bottle mouth.
